(19) United States
(12) Patent Application Publication
(10) Pub. No.: US 2005/0068435 A1
(43) Pub. Date: Mar. 31, 2005

(54) Imaging device and imaging method

(76) Inventors: Michiko Shigemori, Itami-shi (JP); Toshiya Fujii, Otsu-shi (JP); Kazuyuki Inokuma, Yawata-shi (JP); Ryoichi Nagayoshi, Nishinomiya-shi (JP)

Correspondence Address: McDERMOTT WILL & EMERY LLP, 600 13th Street, N.W., Washington, DC, 20005-3096, US

(21) Appl. No.: 10/953,509

(22) Filed: Sep. 30, 2004

(30) Foreign Application Priority Data
Sep. 30, 2003 (JP) 2003-341986

(51) Int. Cl. H04N 5/335

(52) U.S. Cl. 348/272

(57) ABSTRACT

A solid-state image sensor includes photoelectric converters positioned either in a complementary color filter array or in the Bayer color filter array. The solid-state image sensor either adds together electric charges obtained by 9 photoelectric converters that relate to one color in each portion of six rows and six columns of the photoelectric converters so as to output a resulting electric charge as one pixel, or outputs the electric charges obtained by 9 photoelectric converters that relate to one color as 9 pixels without added together. By adding together the electric charges, the resolution of an image becomes one ninth of the case where the electric charges are not added together, and the sensitivity becomes 9 times higher than the same. The control unit not shown in the drawing determines a time length for photoelectric conversion assuming that the electric charges are not added together. If the determined time length is longer than a predetermined threshold, the actual time length for photoelectric conversion is reduced to 1/9 of the determined time length, and an image is generated based on the resulting electric charges that are outputted after the electric charges stored in the photoelectric converters are added together.

### BACKGROUND OF THE INVENTION

(1) Field of the Invention

The present invention relates to an imaging device, and more specifically, it relates to a technique to avoid an image blur due to camera shake and subject move.

(2) Description of the Related Art

In recent years, solid-state image sensors have a larger number of pixels. Solid-state image sensors with a resolution exceeding a megapixel, i.e. one million pixels, are now used even in simple devices such as compact cameras and mobile telephones.

It is known that, when taking a picture using solid-state image sensors, a length of time necessary for photoelectric conversion becomes longer as an amount of light from a subject becomes less, and thus, an image taken with less amount of light is susceptible to image blur due to camera shake and subject move during the photoelectric conversion.

As a conventional technique to avoid an image blur due to camera shake and subject move, compact cameras with an electronic flash that emits fill light have been known.

However, incorporating an electronic flash into mobile telephones is not as easy as the case of compact cameras, due to various constraints such as size, weight, and power supply. Accordingly, fill light is not available when taking pictures using a mobile telephone, even in a case where the amount of light is not sufficient. This forces users taking pictures with a mobile telephone to risk an image blur when the users try to take a picture with less amount of light.

Further, users taking pictures using compact cameras with an electronic flash could suffer the same kind of inconvenience when an amount of power remaining is not enough to light an electronic flash, or in a place where using an electronic flash is prohibited.

### SUMMARY OF THE INVENTION

In the light of the above-noted problems, the present invention aims to provide an imaging device that avoids an image blur due to camera shake and subject move without using fill light, by making a time period for photoelectric conversion shorter in return for a lower resolution.

An imaging device according to the present invention is an imaging device comprising a plurality of photoelectric converters for a plurality of colors, arranged in a two-dimensional matrix, each operable to store a first electric charge by photoelectric conversion and having a color filter corresponding to one of the colors on a light-receiving surface thereof, the matrix being partitioned for each of the colors into portions relating to the color, each portion being L rows and C columns in the matrix, where L≧6 and C≧6, and L and C are even natural numbers; a charge adding unit operable to, for each color and each portion, add together the first electric charges stored in photoelectric converters that have color filters of the color to which the portion relates; a read unit operable to read one of (i) the first electric charges stored in the plurality of photoelectric converters, and (ii) second electric charges obtained as a result of the charge addition by the charge adding unit; a signal processing unit operable to generate image data based on the read electric charges; a conversion time determining unit operable to, based on an amount of light that the plurality of photoelectric converters receive, determine a time period for which the photoelectric conversion is to be performed, assuming that the image data is to be generated based on the first electric charges; and a control unit operable to control the photoelectric converters and the read unit so that (i) if the determined period is longer than a predetermined threshold, the photoelectric converters perform photoelectric conversion for a period shorter than the determined period, and then the read unit reads the second electric charges, and (ii) if not, the photoelectric converters perform photoelectric conversion for the determined period, and then the read unit reads the first electric charges.

Further, the above imaging device may also be such that the control unit controls the photoelectric converters and the read unit so that, if the determined period is longer than the predetermined threshold, the photoelectric converters perform photoelectric conversion for a period shorter than the determined period and equal to or shorter than the predetermined threshold, and then the read unit reads the second electric charges.

By the above construction, when the time period for photoelectric conversion is longer than the predetermined threshold (indicating a tolerance limit of the image blur due to hand movement) because the amount of received light is small, electric charges stored in the photoelectric converters are added together and a resulting electric charge is treated as one pixel. By this, it is possible to reduce the time period for photoelectric conversion without using fill light, in return for a lower resolution. Therefore, it is possible to avoid an image blur due to camera shake and subject move even when pictures are taken with a smaller amount of light.

Moreover, it is possible to obtain an excellent image quality at a low resolution, because the charge adding unit does not skip pixels and adds the electric charges stored in all photoelectric converters except for photoelectric converters that do not form a portion of L rows and C columns.

The above imaging device may also be such that each portion relating to one of the colors deviates from portions relating to the other colors.

By the above construction, it is possible to obtain an excellent image quality, because pixels of different colors indicated by resulting charges are not positioned too closely, and it is more probable for the pixels to be aligned evenly.

The above imaging device may also be such that each portion of L rows and C columns in the matrix, relating to one of the colors, deviates from portions relating to the other colors by L/2 rows, by C/2 columns, or by L/2 rows and C/2 columns, where L=4m+2 and C=4n+2, m and n being natural numbers.

By the above construction, it is possible to obtain an excellent image quality, because pixels of one color indicated by resulting charges are positioned in the middle of pixels of any of other colors, and pixels of all colors are aligned evenly.

The above imaging device may also be such that the charge adding unit, for each portion, adds together the first electric charges stored in LC/4 photoelectric converters in the portion, and the control unit controls the photoelectric converters so that, if the determined period is longer than the predetermined threshold, the photoelectric converters perform photoelectric conversion for a period that is 4/LC times as long as the determined period.

By the above construction, the time period for photoelectric conversion is practically reduced to 4/LC times as long.

The above imaging device may further comprises a light unit operable to, under a predetermined condition, emit fill light, and may be such that the conversion time determining unit determines the time period for which the photoelectric conversion is to be performed, based on whether the fill light is to be emitted, in addition to the amount of light that the photoelectric converters receive.

By the above construction, it is possible to take a picture at a finest resolution, in the case in which the imaging device includes an electronic flash, and in which the time period for photoelectric conversion is reduced by using the electronic flash to an extent where the image blur may be avoided.

The above imaging device may further comprises a reception unit operable to receive a user specification indicating whether suppression of an image blur is necessary, and may be such that the control unit controls the photoelectric converters and the read unit so that, if the received specification indicates that the suppression of an image blur is unnecessary, the photoelectric converters perform photoelectric conversion for the determined period even if the determined period is longer than the predetermined threshold, and then the read unit reads the first electric charges.

By the above construction, in the case in which a user opts to take a picture at a finest resolution at any cost, such as by setting up the imaging device on a tripod, it is possible to meet the user's wishes.

An imaging device according to the present invention may also be an imaging device comprising a plurality of photoelectric converters for a plurality of colors, arranged in a two-dimensional matrix, each operable to store a first electric charge by photoelectric conversion and having a color filter corresponding to one of the colors on a light-receiving surface thereof, the matrix being partitioned for each of the colors into portions relating to the color, each portion being L rows and C columns in the matrix, where L≧6 and C≧6, and L and C are even natural numbers; a charge reading circuit operable to, according to an instruction transmitted to the charge reading circuit, either (i) read the first electric charges stored in the plurality of photoelectric converters, or (ii) read second electric charges obtained by adding together the first electric charges stored in a predetermined number of photoelectric converters; a signal processing circuit operable to generate image data based on the read electric charges; and a control circuit operable to transmit, to the charge reading circuit, based on an amount of light that the photoelectric converters receive, one of a first instruction and a second instruction, the first instruction instructing the charge reading circuit to read the first electric charges, and the second instruction instructing the charge reading circuit to read the second electric charges, for each color and each portion, by adding together the first electric charges in photoelectric converters that have color filters of a same color in one portion.

The above imaging device may also be such that each portion relating to one of the colors deviates from portions relating to the other colors by L/2 rows, by C/2 columns, or by L/2 rows and C/2 columns, where L=4m+2 and C=4n+2, m and n being natural numbers, and the control circuit transmits, to the charge reading circuit, the second instruction that instructs the charge reading circuit to add together, for each color and each portion, the first electric charges stored in photoelectric converters that have color filters of the color to which the portion relates.

The above imaging device may also be such that, if a time period for photoelectric conversion determined based on the amount of light is longer than a predetermined threshold, the control circuit transmits the second instruction to the charge reading circuit after having the photoelectric converters perform photoelectric conversion for a time period equal to or shorter than the predetermined threshold.

By the above construction, it is possible to obtain the same effects as explained above.

An imaging method according to the present invention is an imaging method using a plurality of photoelectric converters for a plurality of colors, arranged in a two-dimensional matrix, each operable to store a first electric charge by photoelectric conversion and having a color filter corresponding to one of the colors on a light-receiving surface thereof, the method comprising a read step of performing, in the matrix that is partitioned for each of the colors into portions relating to the color, each portion being L rows and C columns in the matrix where L≧6 and C≧6, and L and C are even natural numbers, one of a first read and a second read based on an amount of light that the photoelectric converters receive, the first read being an operation of reading the first electric charge in each photoelectric converter, and the second read being an operation of reading a second electric charge obtained, for each color and each portion, by adding together the first electric charges in photoelectric converters that have color filters of the color to which the portion relates; and an image data generation step of generating image data based on the electric charges read in the read step.

The above imaging method may also be such that in the read step, if a time period for photoelectric conversion determined based on the amount of light is longer than a predetermined threshold, the second read is performed after the photoelectric converters perform photoelectric conversion for a period shorter than the determined period and equal to or shorter than the predetermined threshold.

By the above construction, it is possible to obtain the same effects as explained above.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1 illustrates front views of imaging devices, as examples;

FIG. 2 is a functional block diagram illustrating a construction of a main part of an imaging device, as an example;

FIG. 3 is a schematic view illustrating a solid-state image sensor 31 seen from a direction of incoming light;

FIG. 4 illustrates, as an example, a construction of the solid-state image sensor 31, which is realized by a charge-coupled device (CCD) solid-state image sensor;

FIG. 5 illustrates a configuration screen as an example; and

FIG. 6 is a flowchart showing operations for suppressing an image blur.

### DESCRIPTION OF THE PREFERRED EMBODIMENT

An imaging device according to a preferred embodiment of the present invention avoids an image blur due to camera shake and subject move by adding together electric charges stored in a predetermined number of pixels in a solid-state image sensor so as to obtain a resulting electric charge, and by treating the obtained resulting electric charge as an electric charge for one pixel. Thus, it is possible to make a time period for photoelectric conversion shorter in return for a lower resolution, in comparison with a case in which the electric charges are not added together. The following describes the imaging device of the preferred embodiment according to the present invention with reference to the drawings.

<External Appearance>

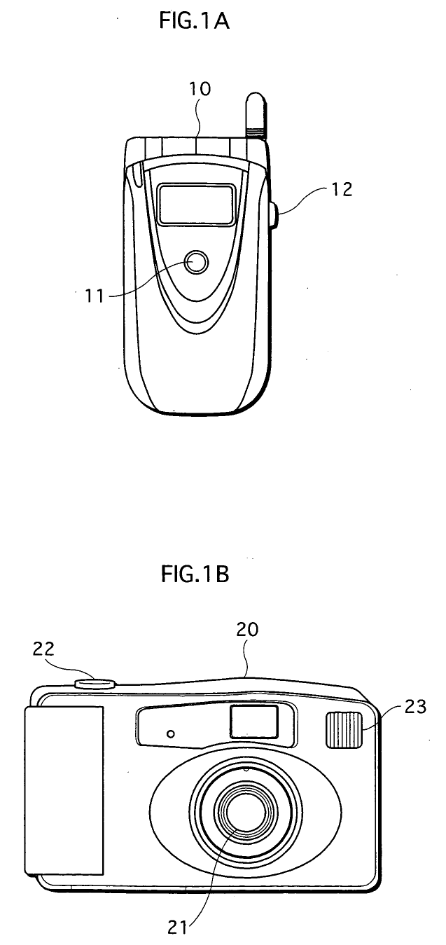

FIGS. 1A and 1B are front views illustrating examples of an eternal appearance of an imaging device.

FIG. 1A illustrates an external appearance of a flip-type mobile telephone 10, as an imaging device, including a lens 11 and a shutter button 12. The mobile telephone 10 is also provided with a display unit and manual operation buttons including cursor keys, at the folded part of the mobile telephone 10, which are visible when the mobile telephone 10 is unfolded.

FIG. 1B illustrates an external appearance of a compact camera, as an imaging device, including a lens 21, a shutter button 22, and an electronic flash 23. The compact camera 20 is also provided with a display unit and manual operation buttons including cursor keys on a reverse side of the compact camera 20 in the drawing.

The cursor keys and display units provided to the mobile telephone 10 and the compact camera 20 are not illustrated in the drawing, because those keys and units are both commonly used and well known.

<Overall Construction>

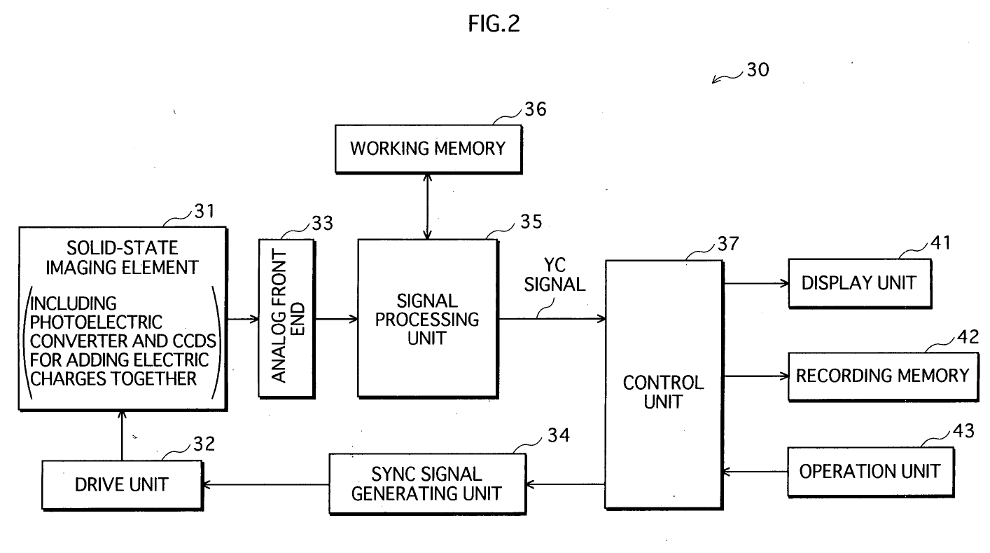

FIG. 2 is a functional block diagram illustrating, as an example, a construction of a main part of an imaging device 30 relating to a subject matter of the present invention.

A solid-state image sensor 31 is such that a plurality of photoelectric converters for a plurality of colors are arranged in a two-dimensional matrix on a semiconductor substrate. Each photoelectric converter has, on its light-receiving surface, a color filter of the color to which the photoelectric converter corresponds. Also, each photoelectric converter converts an amount of light received from an object during a time period indicated by a drive signal sent from a drive unit 32 into an electric charge, and stores the electric charge. The electric charge stored in each photoelectric converter is referred to as a first electric charge in the claims of the present invention.

The solid-state image sensor 31 reads the electric charge stored in each photoelectric converter and outputs a signal corresponding to the read electric charge to an analog front end 33. Alternatively, the solid-state image sensor 31 adds together electric charges in photoelectric converters that have color filters of the same color in each portion of L rows and C columns in the matrix of the photoelectric converters (L≧6 and C≧6, L and C are even natural numbers), thereby obtaining a resulting electric charge, and reads the resulting electric charge for each portion, and output a signal corresponding to the resulting electric charge to the analog front end 33. The electric charge obtained for each portion is referred to as a second electric charge in the claims of the present invention.

It can be changed from one to the other as to whether the solid-state image sensor 31 reads the electric charge stored in each photoelectric converter or reads the resulting electric charge for each portion, in accordance with the drive signal transmitted from the drive unit 32.

Here, it is assumed that the number of pixels having color filters of the same color in each portion of L rows and C columns is LC/4. In the case of reading the resulting electric charge for each portion, the solid-state image sensor 31 has a LC/4-fold sensitivity and a 4/LC-fold resolution, compared with the case of reading the electric charge in each photoelectric converter.

The solid-state image sensor 31 is described in detail later.

The analog front end 33 performs the correlated double sampling (CDS) and the auto gain control (AGC) on the signal received from the solid-state image sensor 31, and then converts the signal into a digital signal.

A signal processing unit 35, a control unit 37 and a sync signal generating unit 34 are specifically realized by using a digital signal processor (DSP), a central processing unit (CPU), a read only memory (ROM) and the like. In detail, functions of these units are realized in such a manner that the DSP and the CPU execute a program stored in the ROM.

The signal processing unit 35 generates a YC signal by processing the digital signal received from the analog front end 33 in a working memory 36. The YC signal expresses a photographed image in luminance and color difference. The working memory 36 is, for example, realized by a synchronous dynamic random access memory (SDRAM).

The control unit 37 displays, in a display unit 41, the photographed image expressed by the received YC signal. The control unit 37 also records the photographed image expressed by the received YC signal in a recording memory 42. The display unit 41 is realized by such as a liquid crystal display (LCD) panel or an electro-luminescence (EL) panel, for example. The recording memory 42 is realized by such as a flash memory or a Ferroelectric RAM (FERAM), for example.

An operation unit 43 is realized by the cursor keys and the shutter button as explained above. The cursor keys are used to accept a user operation for setting configurations for shooting images. The configurations include, in addition to a selection between on and off of the image blur suppression that is a characteristic to the present invention, common and known items such as a selection of a desired resolution. The shutter button is used to receive a user instruction to shoot an image.

The control unit 37, upon reception of the user instruction for shooting, instructs the sync signal generating unit 34 how long the photoelectric conversion is to be performed, and whether stored electric charges are read individually or added together. The sync signal generating unit 34 controls the drive unit 32 so that the drive unit 32 transmits a drive signal that enables the solid-state image sensor 31 to perform the photoelectric conversion and an electric charge read corresponding to the received user instruction, and thus an image shooting is executed.

<Solid-State Image Sensor 31>

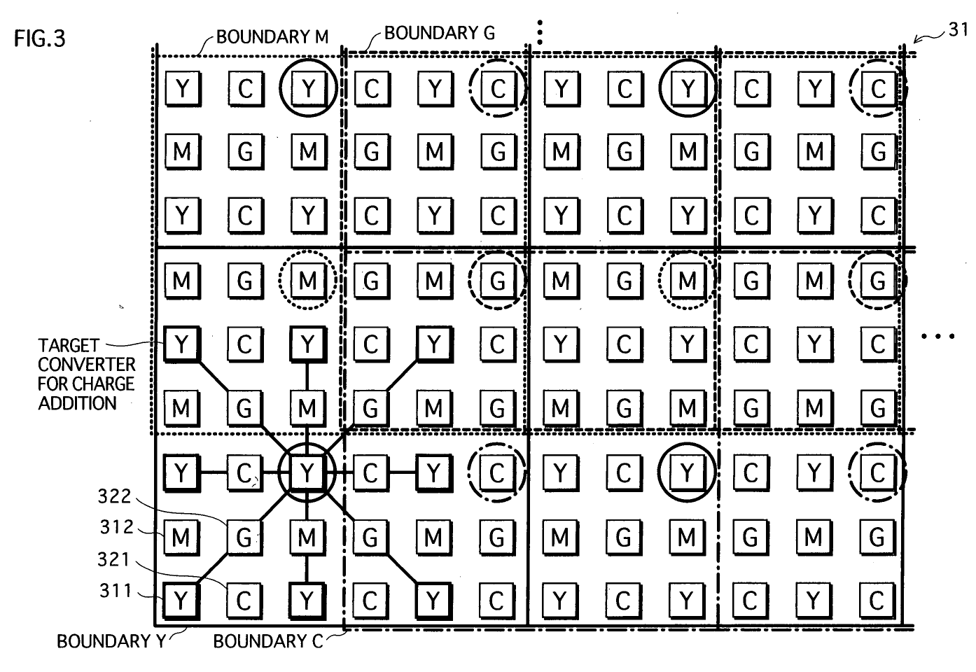

FIG. 3 is a schematic view illustrating the solid-state image sensor 31 viewed from a direction of incoming light, and showing only a part of the solid-state image sensor 31. The solid-state image sensor 31 is such that a plurality of photoelectric converters (311, 312, 321, 322, . . . ) are arranged in a two-dimensional matrix on a semiconductor substrate. The photoelectric converters 311, 312, 321 and 322 respectively have color filters of yellow (Y), magenta (M), cyan (C), and green (G) on their light-receiving surfaces. This color filter array pattern is a typical example of a complementary color filter array pattern. Each of the photoelectric converters in the solid-state image sensor 31 has a color filter of one of the colors in accordance with this array pattern.

The solid-state image sensor 31 has a function of adding together the electric charges, for each portion of six rows and six columns of the matrix of the plurality of photoelectric converters, obtained by photoelectric conversion in photoelectric converters that have color filters of the same color, in order to obtain the resulting electric charge. The following first describes the portions including photoelectric converters whose electric charges are added together (hereinafter referred to as a charge addition portion), and then explains a construction to realize the function for adding together electric charges in detail.

In FIG. 3, as an example, groups of 6×6 charge addition portions, each for yellow, magenta, cyan and green, are respectively defined by a boundary Y, a boundary M, a boundary C, and a boundary G. The example in FIG. 3 is the case where the boundaries Y, M, C, and G each defining a different group of charge addition portions deviate from each other. The boundary Y deviates from the boundary M by three rows, from the boundary C by three columns, and from the boundary G by three rows and three columns.

In a charge addition portion in the group defined by the boundary Y, continuous lines indicate nine photoelectric converters that have color filters of yellow and whose electric charges are added together. A circle within the boundary Y represents a location of a yellow pixel indicated by a resulting electric charge obtained by the charge addition in the portion defined by the boundary Y. Which is to say, the circle represents a center of the nine pixels whose electric charges are added together.

Circles in other portions in the groups defined by the rest of the boundaries indicate locations of a pixel in each portion. In each charge addition portion, an electric charge stored in a photoelectric converter indicated by a circle and electric charges in photoelectric converters that have color filters of the same color as the circled element and are located the closest to the circled element in row, column and diagonal directions are added together.

Pixels indicated by resulting electric charges obtained by charge addition are arranged at even intervals in a two-dimensional matrix, similarly to the original pixels, and also have the same color filter array pattern as the original pixels. The solid-state image sensor 31 adds together electric charges in photoelectric converters of the solid-state image sensor 31, except for photoelectric converters located near edges of the semiconductor substrate and do not form a full charge addition portion.

Note that the boundaries, the continuous lines and the circles illustrated in FIG. 3 are only provided for an explanation purpose and are not physically formed on the semiconductor substrate as constituents of the solid-state image sensor 31.

<Detailed Description of Construction and Operation>

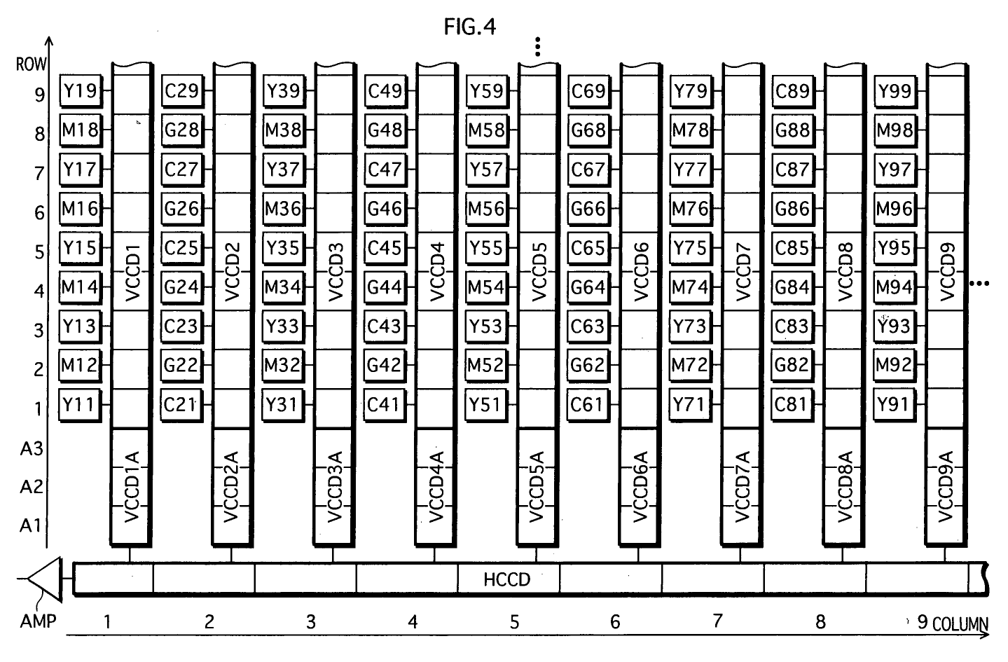

FIG. 4 illustrates, as an example, a specific construction for achieving the above-mentioned addition and read of the electric charges in the solid-state image sensor 31, which is realized by a CCD solid-state image sensor.

In FIG. 4, photoelectric converters (Y11, M12, C21, and G22, . . . ) each have a color filter in accordance with the color filter array pattern described above. Vertical CCDs (VCCD 1, VCCD 2, . . . ) are provided in one-to-one correspondence with the columns of the matrix. Each vertical CCD is made up of a plurality of stages in one-to-one correspondence with the rows of the matrix. Each vertical CCD receives an electric charge from each of corresponding photoelectric converters. Here, the individual electric charges are transferred as they are, or added together while transferred. Connection CCDs (VCCD 1A, VCCD 2A, . . . ) are provided, at one end of each vertical CCD, in one-to-one correspondence with the vertical CCDs (VCCD 1, VCCD 2, . . . ). Each connection CCD is made up of stages corresponding to three rows. Also, each connection CCD transfers an electric charge from a corresponding one of the vertical CCDs to a horizontal CCD (HCCD). The horizontal CCD is made up of stages in one-to-one correspondence with the columns of the matrix. The horizontal CCD receives an electric charge from each of the vertical CCDs. Here, the individual electric charges are transferred as they are, or added together to obtain a resulting electric charge while transferred. An output amplifier (AMP) outputs an electric signal corresponding to an electric charge received from the horizontal CCD.

A read circuit described in Claims refers to the CCDs and the output amplifier.

To drive the solid-state image sensor 31 with this construction, the drive unit 32 under control of the sync signal generating unit 34 sends a storing signal, a read signal, a vertical transfer signal, a connection transfer signal, and a horizontal transfer signal, to the solid-state image sensor 31.

The solid-state image sensor 31 has wirings to simultaneously send the storing signal to all of the photoelectric converters. The photoelectric converters each convert, into an electric charge, light received from an object during reception of the storing signal, and store the electric charge. Note that, the wirings explained above and below are not illustrated in FIG. 4, for better viewablility.

The read signal includes a first read signal, a second read signal, and a third read signal that are individually sent. The solid-state image sensor 31 has wirings to send the first read signal to all photoelectric converters in 3i-th rows (i is a natural number) simultaneously, the second read signal to all photoelectric converters in (3i-1)-th rows (i is a natural number) simultaneously, and the third read signal to all photoelectric converters in (3i-2)-th rows (i is a natural number) simultaneously. When a corresponding one of the first to third read signals is received, each photoelectric converter transfers an electric charge to a corresponding stage in the vertical CCDs.

The vertical transfer signal includes a first vertical transfer signal, a second vertical transfer signal, and a third vertical transfer signal, which are individually sent. The solid-state image sensor 31 has wirings to send the first vertical transfer signal to all vertical CCDs in 3j-th columns (j is a natural number) simultaneously, the second vertical transfer signal to all vertical CCDs in (3j-1)-th columns (j is a natural number) simultaneously, and the third vertical transfer signal to all vertical CCDs in (3j-2)-th columns (j is a natural number) simultaneously. When a corresponding one of the first to third vertical transfer signals is received, electric charges stored in respective stages in each vertical CCD are transferred one stage in the downward direction.

The following part describes how electric charges are added together while transferred in each vertical CCD, with reference to the above-mentioned control signals.

To start with, when the second read signal is sent, electric charges stored in photoelectric converters in the second, fifth, eighth rows, . . . are each transferred to a corresponding stage in each vertical CCD. After this, the first, second and third vertical transfer signals are each sent twice. Thus, the received electric charges in each vertical CCD are transferred two stages in the downward direction. Specifically speaking, an electric charge received from a photoelectric converter in the eighth row has been transferred to a stage corresponding to the sixth row in each vertical CCD, and an electric charge received from a photoelectric converter in the fifth row has been transferred to a stage corresponding to the third row in each vertical CCD.

The first read signal is next sent. Accordingly, electric charges in photoelectric converters in the third, sixth, ninth rows, . . . are each transferred to a corresponding stage in each vertical CCD. In this way, electric charges received from the photoelectric converters in the eighth and sixth rows are added together, to obtain an electric charge for two pixels, in a stage corresponding to the sixth row in each vertical CCD. Similarly, electric charges received from the photoelectric converters in the fifth and third rows are added together, to obtain an electric charge for two pixels, in a stage corresponding to the third row in each vertical CCD.

After this, the first, second and third vertical transfer signals are each sent twice. Thus, the electric charges for two pixels in each vertical CCD are transferred two stages in the downward direction. Then, the third read signal is sent, so that electric charges in photoelectric converters in the first, fourth, seventh rows, . . . are each transferred to a corresponding stage in each vertical CCD. In this way, electric charges received from the photoelectric converters in the eighth, sixth and fourth rows are added together, to obtain an electric charge for three pixels, in a stage corresponding to the fourth row in each vertical CCD. Similarly, electric charges received from the photoelectric converters in the fifth, third and first rows are added together, to obtain an electric charge for three pixels, in a stage corresponding to the first row in each vertical CCD.

The following part describes other control signals.

The connection transfer signal includes a first connection transfer signal, a second connection transfer signal, and a third connection transfer signal, which are individually sent. The solid-state image sensor 31 has wirings to send the first connection transfer signal to all connection CCDs in 3j-th columns (j is a natural number) simultaneously, the second connection transfer signal to all connection CCDs in (3j-1)-th columns (j is a natural number) simultaneously, and the third connection transfer signal to all connection CCDs in (3j-2)-th columns (j is a natural number) simultaneously. When a corresponding one of the first to third connection transfer signals is received, electric charges stored in respective stages in each connection CCD are transferred one stage in the downward direction, and an electric charge in the lowest stage to a corresponding stage in the horizontal CCD.

The solid-state image sensor 31 has wirings to send the horizontal transfer signal to the horizontal CCD. When the horizontal transfer signal is received, electric charges in respective stages in the horizontal CCD are transferred one stage in the leftward direction.

The following part describes how electric charges are added together while transferred in the horizontal CCD, with reference to the above-described control signals.

The first, second and third vertical transfer signals and the first, second and third connection transfer signals are each sent three times. Thus, an electric charge for three pixels is transferred to the lowest stage in each connection CCD.

After this, when the second connection transfer signal is received, an electric charge for three pixels in the lowest stage in each of the connection CCDs in the second, fifth, eighth columns, . . . is transferred to a corresponding stage in the horizontal CCD. Then, the horizontal transfer signal is sent twice, so that the received electric charges for three pixels in the horizontal CCD are transferred two stages in the leftward direction. Specifically speaking, an electric charge for three pixels received in the stage corresponding to the eighth column is transferred to a stage corresponding to the sixth column in the horizontal CCD. Similarly, an electric charge for three pixels received in the stage corresponding to the fifth column is transferred to a stage corresponding to the third column in the horizontal CCD.

Then, when the first connection transfer signal is received, an electric charge for three pixels in the lowest stage in each of the connection CCDs in the third, sixth, ninth columns, . . . is transferred to a corresponding stage in the horizontal CCD. Thus, the electric charges for three pixels from the connection CCDs in the eighth and sixth columns are added together, to obtain an electric charge for six pixels, in the stage corresponding to the sixth column in the horizontal CCD. Similarly, the electric charges for three pixels from the connection CCDs in the fifth and third columns are added together, to obtain an electric charge for six pixels, in the stage corresponding to the third column in the horizontal CCD.

After this, the horizontal transfer signal is again sent twice. Thus, the electric charges for six pixels in the horizontal CCD are transferred two stages in the leftward direction. When the third connection transfer signal is received, an electric charge for three pixels in the lowest stage in each of the connection CCDs in the first, fourth, seventh columns, . . . is transferred to a corresponding stage in the horizontal CCD. Thus, the electric charges for three pixels from the connection CCDs in the eighth, sixth and fourth columns are added together, to obtain an electric charge for nine pixels, in the stage corresponding to the fourth column in the horizontal CCD. Similarly, the electric charges for three pixels from the connection CCDs in the fifth, third and first columns are added together, to obtain an electric charge for nine pixels, in the stage corresponding to the first column in the horizontal CCD.

The electric charges for nine pixels in the horizontal CCD are output to the analog front end 33 through the output amplifier (AMP).

As described above, the solid-state image sensor 31 has a distinctive construction to individually transfer electric charges stored in photoelectric converters in each predetermined group of rows to the vertical CCDs and to individually transfer electric charges in vertical CCDs in each predetermined group of columns to the horizontal CCD.

This construction enables the solid-state image sensor 31 to add together electric charges while electric charges are transferred in each vertical CCD and the horizontal CCD, in accordance with the distinctive-control signals sent from the drive unit 32. Accordingly, the solid-state image sensor 31 can add together electric charges, to obtain a resulting electric charge for nine pixels, and outputs the resulting electric charge as one pixel.

The drive unit 32 may send conventional control signals. According to the conventional control signals, electric charges in the photoelectric converters in all of the rows are simultaneously transferred to each vertical CCD, and electric charges in the vertical CCDs in all of the columns are simultaneously transferred to the horizontal CCD through the connection CCDs. If such is the case, the solid-state image sensor 31 outputs an electric charge stored in each one of the photoelectric converters as one pixel.

Each stage of the vertical CCDs, the connection CCDs and the horizontal CCD may be made up of a plurality of gates. When each stage is made up of two gates, each of the first to third vertical transfer signals consists of two control signals of different phases for driving the two gates, and each vertical CCD is driven by six control signals of different phases. Also, the horizontal CCD is driven by two control signals of different phases.

The boundaries for the respective colors may define the charge addition portions of the same color, or the charge addition portions of different colors. Furthermore, if pixels indicated by resulting electric charges obtained by charge addition are not arranged at even intervals in a two-dimensional matrix, a filter to correct the uneven arrangement may be employed.

A charge addition portion for each color may have L rows and C columns, where L=4m+2, C=4n+2, and m and n are natural numbers. Also, a boundary for one of the colors to define a group of charge addition portions may deviate from boundaries for the other colors by L/2 rows, by C/2 columns, and by L/2 rows and C/2 columns. In the above description about the solid-state image sensor 31, m and n are set at one, i.e. the charge addition portion has six rows and six columns, and the boundary Y deviates from the boundary M by three rows, from the boundary C by three columns, and from the boundary G by three rows and three columns.

The Bayer color filter array may be used for the color filter array in the present embodiment. A repetitive part of the color filter array pattern may have four rows and two columns. In this repetitive part, photoelectric converters of the first row and first column and the third row and second column have color filters of the same color. The same applies to photoelectric converters of the first row and the second column and the third row and the first column, photoelectric converters of the second row and the first column and the fourth row and the second column, and photoelectric converters of the second row and the second column and the fourth row and the first column. Alternatively, the repetitive part of the color filter array pattern may have two rows and four columns. In this case, photoelectric converters of the first row and first column and the second row and third column have color filters of the same color. The same applies to photoelectric converters of the second row and the first column and the first row and the third column, photoelectric converters of the first row and the second column and the second row and the fourth column, and photoelectric converters of the second row and the second column and the first row and the fourth column.

The drive unit 32 may individually send first to sixth read signals and first to sixth connection transfer signals, to the solid-state image sensor 31. Here, the solid-state image sensor 31 may have wirings to send read signals different from each other respectively to photoelectric converters in six successive rows, and wirings to send connection transfer signals different from each other respectively to connection CCDs in six successive columns.

It is also possible to read the resulting electric charge after adding together electric charges in the charge addition portion in a Metal Oxide Semiconductor (MOS) solid-state image sensor, instead of the CCD solid-state image sensor.

<Image Blur Suppression>

The following describes operations for avoiding an image blur due to camera shake and subject move (image blur suppression) of the imaging device 30.

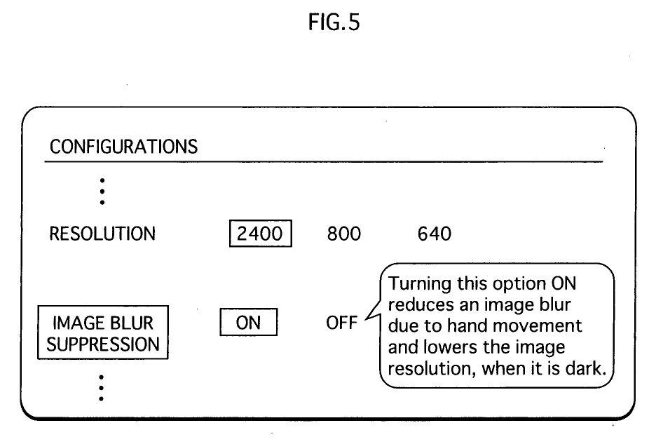

FIG. 5 illustrates a configuration screen, as an example, for receiving a user operation for setting configurations for images shooting. The configuration screen is displayed in the display unit of the imaging device 30 according to an operation of the cursor keys by a user.

The user may specify settings of the imaging device 30, via the configuration screen, for the desired resolution, on or off of the image blur suppression, and other conditions for image shooting. The imaging device 30 stores the specified settings in a built-in memory.

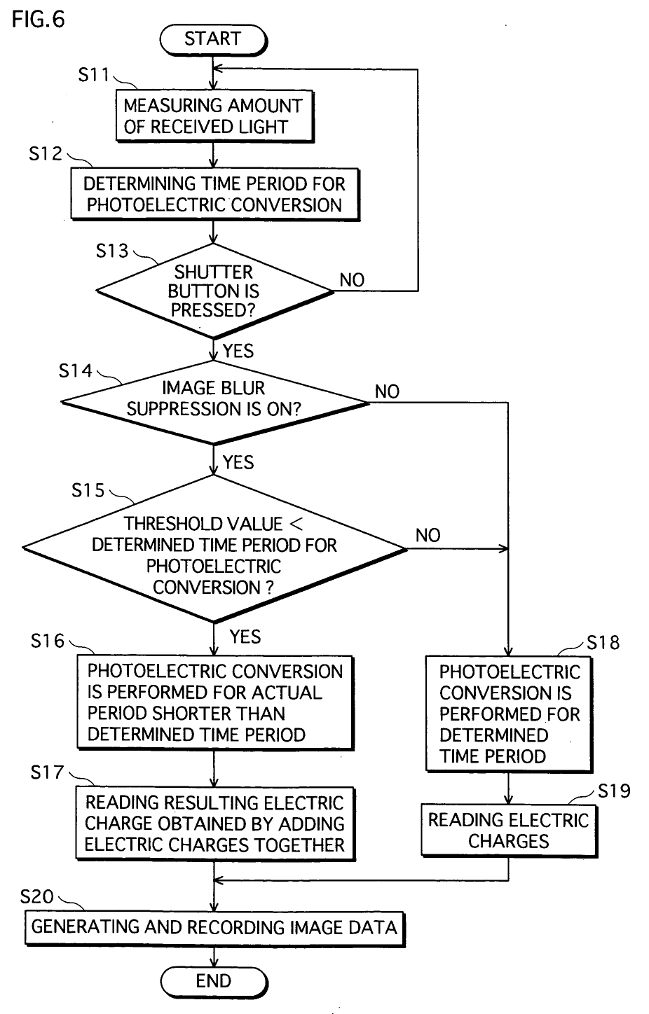

FIG. 6 is a flowchart showing the operations of the image blur suppression. Specifically, the flowchart shows the operations of the imaging device 30 from a point of time prior to pressing of the shutter button until image data as a result of shooting is recorded, when the user specifies a finest resolution for resulting images.

The solid-state image sensor 31 measures the amount of light received from the photographic subject, and outputs information indicating the measured amount of light to the control unit 37 via the analog front end 33 and signal processing unit 35 (S1).

The control unit 37 determines how long the photoelectric conversion is to be performed (a time period for photoelectric conversion) according to the amount of light indicated by the received information, provided that the desired resolution for the resulting image is the finest, i.e. the image data is generated based on the electric charge stored in each photoelectric converter of the solid-state image sensor 31 without being added together (S12).

The imaging device 30 repeats the measuring the amount of light and determining the time period for photoelectric conversion (S13: NO) until the user presses the shutter button to instruct to shoot an image.

Upon pressing of the shutter button (S13: YES), if the image blur suppression is on (S14: YES), and if the determined time period for photoelectric conversion is longer than a predetermined threshold that indicates a tolerance limit for the image blur (S15: YES), the control unit 37 transmits, to the sync signal generating unit 34, an instruction that the photoelectric conversion is to be performed for an actual time period shorter than the determined time period so as to store electric charges, and that, after the stored electric charges are added together after the conversion, a resulting charge is to be read. The drive unit 32, according to the instruction received via the sync signal generating unit 34, transmits a storing signal to the solid-state image sensors 31 for the actual time for photoelectric conversion in order to store the electric charges (S16), and then transmits a control signal, to the solid-state image sensor 31, for adding together the electric charges to obtain the resulting electric charge as the electric charges are transferred, and outputs a signal corresponding to the resulting charge (S17).

Note that it is desirable for the actual time for photoelectric conversion to be equal to or shorter than the threshold, in order to satisfy the tolerance limit for an image blur.

In other cases (S14: NO, or S15: NO), the control unit 37 transmits, to the sync signal generating unit 34, an instruction that the photoelectric conversion is to be performed for the determined time period, and that the electric charges stored in the photoelectric converters are read without being added together after the conversion. According to the instruction received via the sync signal generating unit 34, the drive unit 32 transmits a storing signal to the solid-state image sensors 31 for the determined time period in order to store the electric charges (S18), and then transmits, to the solid-state image sensors 31, a control signal for transferring the electric charges individually without being added together, and outputs signals corresponding to the electric charges that are not added together (S19).

The signal processing unit 35 generates the image data by processing the signals outputted from the solid-state image sensor 31, and records the image data in the recording memory 42 via the control unit 37 (S20).

### MODIFIED EXAMPLES

Although the present invention is explained based on the embodiment as described above, the present invention is not restricted to the above embodiment. Various modifications as explained below are also included in the present invention.

1. The present invention may be a method including the steps as explained in the embodiment. The present invention may also be a computer program to realize the method executed by a computer, or digital signals expressing the computer program.

Further, the present invention may also be a computer readable storage medium recorded with the program or the digital signals. Examples of the computer readable storage medium include a flexible disc, a hard disk, a CD-ROM, an MO, a DVD, a BD, and a semiconductor memory.

In addition, the present invention may also be the computer program or the digital signals that is transmitted via a telecommunication line, a wireless connection, a cable communication line, or a network such as the Internet.

2. In the preferred embodiment, the example in which the imaging device is incorporated in a mobile telephone is described. However, a case in which the imaging device is incorporated in a compact camera is also included in the present invention. Even though it is assumed that popular compact cameras are provided with an electronic flash, the present invention is effective in the case in which images are taken with such a compact camera when the amount of light is not sufficient but using an electronic flash is not permitted, as explained in the section of the present specification describing the problems to solve.

When the imaging device is incorporated in a compact camera, it is also possible to add, in the configuration screen, a selection between turning on and off the electronic flash, so that the user may specify the preference and the control unit determines the time period for photoelectric conversion considering the specified user preference for the electronic flash. If, by using the electronic flash, the period for photoelectric conversion becomes shorter than the predetermined threshold, the image shooting may be performed at the finest resolution.

3. The present invention also includes a construction for realizing the function for the image blur suppression described in the preferred embodiment by reading the resulting electric charge after adding together electric charges obtained using a MOS solid-state image sensor.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

1. An imaging device comprising:
a plurality of photoelectric converters for a plurality of colors, arranged in a two-dimensional matrix, each operable to store a first electric charge by photoelectric conversion and having a color filter corresponding to one of the colors on a light-receiving surface thereof, the matrix being partitioned for each of the colors into portions relating to the color, each portion being L rows and C columns in the matrix, where L≧6 and C≧6, and L and C are even natural numbers;
a charge adding unit operable to, for each color and each portion, add together the first electric charges stored in photoelectric converters that have color filters of the color to which the portion relates;
a read unit operable to read one of (i) the first electric charges stored in the plurality of photoelectric converters, and (ii) second electric charges obtained as a result of the charge addition by the charge adding unit;
a signal processing unit operable to generate image data based on the read electric charges;
a conversion time determining unit operable to, based on an amount of light that the plurality of photoelectric converters receive, determine a time period for which the photoelectric conversion is to be performed, assuming that the image data is to be generated based on the first electric charges; and
a control unit operable to control the photoelectric converters and the read unit so that (i) if the determined period is longer than a predetermined threshold, the photoelectric converters perform photoelectric conversion for a period shorter than the determined period, and then the read unit reads the second electric charges, and (ii) if not, the photoelectric converters perform photoelectric conversion for the determined period, and then the read unit reads the first electric charges.

2. An imaging device according to claim 1, wherein
the control unit controls the photoelectric converters and the read unit so that, if the determined period is longer than the predetermined threshold, the photoelectric converters perform photoelectric conversion for a period shorter than the determined period and equal to or shorter than the predetermined threshold, and then the read unit reads the second electric charges.

3. An imaging device according to claim 1, wherein
each portion relating to one of the colors deviates from portions relating to the other colors.

4. An imaging device according to claim 3, wherein
each portion of L rows and C columns in the matrix, relating to one of the colors, deviates from portions relating to the other colors by L/2 rows, by C/2 columns, or by L/2 rows and C/2 columns, where L=4m+2 and C=4n+2, m and n being natural numbers.

5. An imaging device according to claim 1, wherein
the charge adding unit, for each portion, adds together the first electric charges stored in LC/4 photoelectric converters in the portion, and
the control unit controls the photoelectric converters so that, if the determined period is longer than the predetermined threshold, the photoelectric converters perform photoelectric conversion for a period that is 4/LC times as long as the determined period.

6. An imaging device according to claim 1, further comprising:
a light unit operable to, under a predetermined condition, emit fill light, wherein
the conversion time determining unit determines the time period for which the photoelectric conversion is to be performed, based on whether the fill light is to be emitted, in addition to the amount of light that the photoelectric converters receive.

7. An imaging device according to claim 1, further comprising:
a reception unit operable to receive a user specification indicating whether suppression of an image blur is necessary, wherein
the control unit controls the photoelectric converters and the read unit so that, if the received specification indicates that the suppression of an image blur is unnecessary, the photoelectric converters perform photoelectric conversion for the determined period even if the determined period is longer than the predetermined threshold, and then the read unit reads the first electric charges.

8. An imaging device comprising:
a plurality of photoelectric converters for a plurality of colors, arranged in a two-dimensional matrix, each operable to store a first electric charge by photoelectric conversion and having a color filter corresponding to one of the colors on a light-receiving surface thereof, the matrix being partitioned for each of the colors into portions relating to the color, each portion being L rows and C columns in the matrix, where L≧6 and C≧6, and L and C are even natural numbers;
a charge reading circuit operable to, according to an instruction transmitted to the charge reading circuit, either (i) read the first electric charges stored in the plurality of photoelectric converters, or (ii) read second electric charges obtained by adding together the first electric charges stored in a predetermined number of photoelectric converters;
a signal processing circuit operable to generate image data based on the read electric charges; and
a control circuit operable to transmit, to the charge reading circuit, based on an amount of light that the photoelectric converters receive, one of a first instruction and a second instruction, the first instruction instructing the charge reading circuit to read the first electric charges, and the second instruction instructing the charge reading circuit to read the second electric charges, for each color and each portion, by adding together the first electric charges in photoelectric converters that have color filters of a same color in one portion.

9. An imaging device according to claim 8, wherein
each portion relating to one of the colors deviates from portions relating to the other colors by L/2 rows, by C/2 columns, or by L/2 rows and C/2 columns, where L=4m+2 and C=4n+2, m and n being natural numbers, and
the control circuit transmits, to the charge reading circuit, the second instruction that instructs the charge reading circuit to add together, for each color and each portion, the first electric charges stored in photoelectric converters that have color filters of the color to which the portion relates.

10. An imaging device according to claim 8, wherein
if a time period for photoelectric conversion determined based on the amount of light is longer than a predetermined threshold, the control circuit transmits the second instruction to the charge reading circuit after having the photoelectric converters perform photoelectric conversion for a time period equal to or shorter than the predetermined threshold.

11. An imaging method using a plurality of photoelectric converters for a plurality of colors, arranged in a two-dimensional matrix, each operable to store a first electric charge by photoelectric conversion and having a color filter corresponding to one of the colors on a light-receiving surface thereof, the method comprising:
a read step of performing, in the matrix that is partitioned for each of the colors into portions relating to the color, each portion being L rows and C columns in the matrix where L≧6 and C≧6, and L and C are even natural numbers, one of a first read and a second read based on an amount of light that the photoelectric converters receive, the first read being an operation of reading the first electric charge in each photoelectric converter, and the second read being an operation of reading a second electric charge obtained, for each color and each portion, by adding together the first electric charges in photoelectric converters that have color filters of the color to which the portion relates; and
an image data generation step of generating image data based on the electric charges read in the read step.

12. An imaging method according to claim 11, wherein
in the read step, if a time period for photoelectric conversion determined based on the amount of light is longer than a predetermined threshold, the second read is performed after the photoelectric converters perform photoelectric conversion for a period shorter than the determined period and equal to or shorter than the predetermined threshold.
